(19) United States
(12) Patent Application Publication
(10) Pub. No.: US 2018/0280760 A1
(43) Pub. Date: Oct. 4, 2018

(54) APPARATUS AND METHOD FOR DETERMINING ATHLETIC READINESS

(71) Applicant: Under Armour, Inc., Baltimore, MD (US)

(72) Inventors: PAUL WINSPER, Portland, OR (US); Kris Homsi, Portland, OR (US); Grant Kovach, Baltimore, MD (US); Jeffery Allen, Baltimore, MD (US); Angela Nelligan, Baltimore, MD (US)

(21) Appl. No.: 15/477,248

(22) Filed: Apr. 3, 2017

(51) Int. Cl. A63B 24/00; H04M 1/725; H04Q 9/00; G09B 5/02; G09B 19/00

(52) U.S. Cl. CPC A63B 24/0062; H04M 1/7253; H04Q 9/00; A63B 2024/0065; G09B 19/0038; H04M 2250/12; H04Q 2209/43; G09B 5/02

(57) ABSTRACT

Apparatus and method for determining workout or training readiness. In one embodiment, the method comprises establishing communication between a mobile device associated to the user and a sensor disposed in or on at least one shoe of the user, providing via a display of the mobile device an instruction to the user to perform one or more jumps, transmitting a signal from the mobile device to the sensor, the signal causing the sensor to begin collection of data, and the transmission being timed to coincide with the performance of the one or more jumps, receiving from the sensor the data relating to the performance of the one or more jumps, processing the data at a processor of the mobile device to determine a readiness score of the user, and displaying at least the readiness score to the user via the display of the mobile device.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates generally to the field of athletic readiness. More particularly, the present disclosure relates to systems, computer programs, devices, and methods for providing a user with a means to determine his/her state of readiness for a given activity, and in some embodiments, provide recommendations regarding how the user should proceed (e.g., go for a training run, participate in a sporting competition, etc.).

### BACKGROUND

In recent years, health and fitness tracking applications have become very popular. Users log their activity manually and/or via the use of one or more computerized devices for sensing particular activity. Health and fitness tracking applications allow users to set and achieve personalized health goals by tracking the calories they burn in some cases this is compared to the foods and beverages that they consume. These applications enable users to gain insights that help them make smarter choices and create healthier habits.

However, activity tracking, even via computerized applications is unable to predict a user's capacity to engage in an activity prior to his/her participation in the activity. Training at an intensity level and/or with a load that outstrips the athlete's capacity to perform or fully recover can result in overreaching, overtraining, and an elevated risk of illness or injury. Hence what is needed are improved methods for determining workout or training readiness.

### SUMMARY

The present disclosure addresses the foregoing needs by disclosing, inter alia, methods, devices, systems, and computer programs for determining workout or training readiness.

In one aspect of the disclosure, method for determining an readiness of a user is provided. In one embodiment, the method comprises: (i) establishing communication between a mobile device associated to the user and a sensor disposed in or on at least one shoe of the user; (ii) providing via a display of the mobile device an instruction to the user to perform one or more jumps; (iii) transmitting a signal from the mobile device to the sensor, the signal causing the sensor to begin collection of data, and the transmission being timed to coincide with the performance of the one or more jumps; (iv) receiving from the sensor the data relating to the performance of the one or more jumps; (v) processing the data at a processor of the mobile device to determine a readiness score of the user; and (vi) displaying at least the readiness score to the user via the display of the mobile device.

In another aspect of the disclosure, a non-transitory, computer readable medium is provided. In one embodiment, the computer readable medium comprises a plurality of instructions which are configured to, when executed, cause a user device to: (i) associate a sensor disposed at a shoe to a user which is also associated to the user device; (ii) display an instruction to the user to perform one or more jumps at a specified time; (iii) transmit a signal to the sensor at the specified time to begin collection of data relating to the performance of the one or more jumps; (iv) receive the data relating to the performance of the one or more jumps; (v) compare one or more aspects of the data to a standard therefor; (vi) based on the comparison, identify a readiness score; and (vii) display the readiness score and at least one recommendation based thereon to the user.

In yet another aspect of the present disclosure, a mobile user device configured to determine a readiness of a user is disclosed. In one embodiment, the mobile user device comprises: a transceiver apparatus configured to communicate to and from a sensor device disposed at a user's shoe, the user being associated to the mobile user device; a user interface; a storage apparatus; and a processor configured to execute at least one computer application thereon, the computer application comprising a plurality of instructions which are configured to, when executed by the processor cause the mobile user device to: (i) display via the user interface an instruction for the user to perform one or more jumps; (ii) cause the sensor to collect data relating to the performance of the one or more jumps; (iii) receive the data relating to the performance of the one or more jumps; (iv) determine a readiness score of the user based on a comparison of the data relating to the performance of the one or more jumps to standard data relating thereto and stored in the storage apparatus; and (v) display the readiness score at the user interface.

These and other aspects of the disclosure shall become apparent when considered in light of the disclosure provided herein.

### BRIEF DESCRIPTION OF THE DRAWINGS

The accompanying drawings, which are incorporated in and form a part of the specification, illustrate example embodiments and, together with the description, serve to explain the principles of the disclosure. In the drawings:

FIG. 1A is a profile view of an exemplary prior art jump testing system.

FIG. 1B is a top view of an exemplary prior art jump testing system.

FIG. 2 is a diagram illustrating an exemplary readiness testing system in accordance with one embodiment of the present disclosure.

FIG. 3 is a profile view of an exemplary readiness testing system in accordance with one embodiment of the present disclosure.

FIG. 4 is a block diagram illustrating an exemplary evaluation pod in accordance with one embodiment of the present disclosure.

FIG. 5 is a block diagram illustrating an exemplary mobile device in accordance with one embodiment of the present disclosure.

FIG. 6 is a logical flow diagram illustrating an exemplary method for determining the readiness of an athlete in accordance with one embodiment of the present disclosure.

FIG. 7 is a logical flow diagram illustrating another exemplary method for determining a readiness level of an athlete in accordance with another embodiment of the present disclosure.

FIG. 8A is a graphical representation of various exemplary ground contact time thresholds utilized for determining readiness in accordance with one embodiment of the present disclosure.

FIG. 8B is an exemplary graphical user interface for displaying one or more flight time representations and a readiness score for an athlete in accordance with one embodiment of the present disclosure.

FIGS. 9A-C are block diagrams illustrating a mobile device displaying exemplary readiness levels of an athlete in accordance with one embodiment of the present disclosure.

All Figures © Under Armour, Inc. 2017. All rights reserved.

### DETAILED DESCRIPTION

Disclosed embodiments include systems, apparatus, methods and storage media which enable determination of workout or training readiness.

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). Similar logic applies to the use of the term “or” herein; i.e., “A or B” means (A), (B), or (A and B).

The terms “comprising,” “including,” “having,” and the like, as used with respect to embodiments of the present disclosure, are synonymous.

### Exemplary Embodiments

One of the emerging tools of performance training is tuning an athlete's workout intensity or training plan based on the athlete's readiness. Readiness can be understood as an athletic construct pertaining to the capacity of the athlete to perform a workout or manage a certain training load. Readiness can be determined in a number of ways, including using the output of a jump test. In addition, the herein described apparatus and methods may be useful in: tracking an athlete's recovery status, informing training intensity, and mitigating the risk of injury (such as from overtraining).

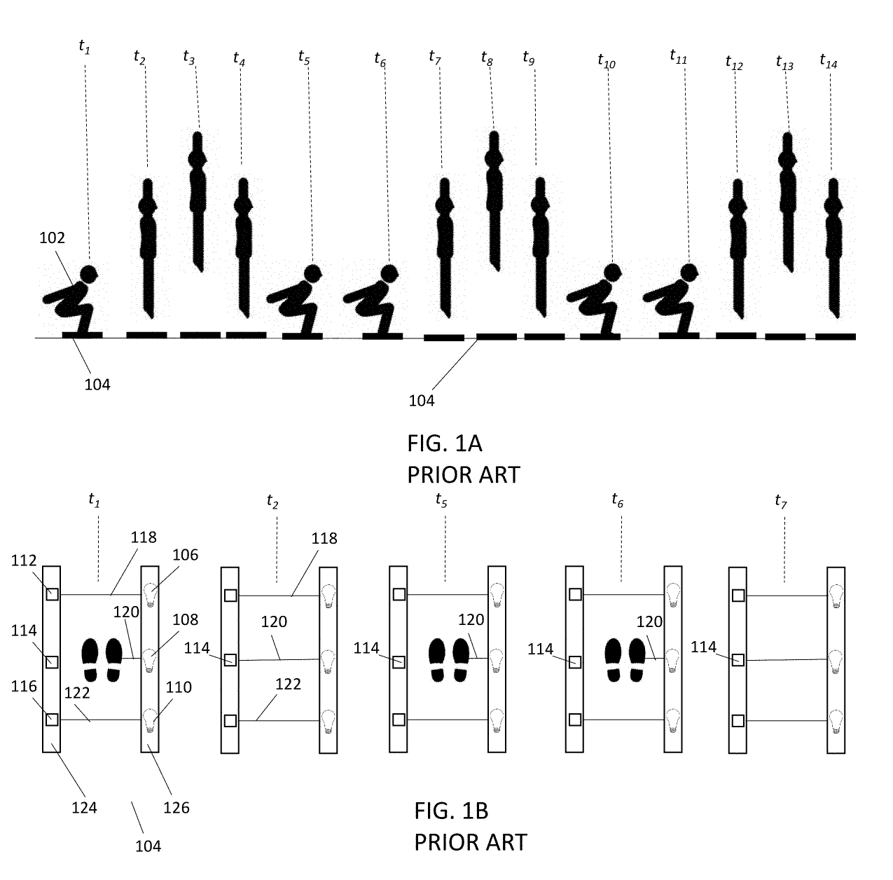

FIGS. 1A and 1B illustrate various views of exemplary prior art jump testing systems.

As shown, a prior art jump test begins at time t₁ with an athlete 102 preparing to jump while on a platform 104. Platform 104 may be part of a prior art jump detection system which further includes at least a first or left-side rail 124 and a second or right-side rail 126. In the illustrated embodiment, the right-side rail 126 includes at least three light sources (light source 106, light source 108, and light source 110). The left-side rail 124 includes at least three detectors (detector, 112, detector 114, and detector 116) in the illustrated embodiment. The detectors 112-116 are in communication with a computer and are configured to notify the computer when the detectors 112-116 detect light. As shown, the first light source 106 directs a first light beam 118 toward the first detector 112, a second light source 108 directs a second light beam 120 toward the second detector 114, and the third light source 110 directs a third light beam 122 toward the third detector 116.

The first and second rails 124 and 126 are parallel to each other and spaced apart from each other such that the feet of the athlete 102 can comfortably fit in between them during the jump test. The rails 124 and 126 are also positioned such that the light beams 118-122 are able to reach the detectors 112-116, respectively, when nothing is obstructing the light beams. The rails 124 and 126 may be of suitable height so as to ensure that the light beams 118-122 are obstructed when a user's feet are positioned on the platform 104, i.e., the light sources 106-110 and detectors 112-116 are placed at or near the bottom of the platform 104.

At a first time, t₁, the feet of the athlete 102 are blocking the light beam 120 from reaching the detector 114. The detector 114 notifies the computer that no light is reaching the detector 114. In the context of the jump test, the computer interprets the obstruction to mean that the athlete 102 is on the ground/platform 104.

The athlete 102 jumps at time t₂ and accordingly, his feet leave the platform 104. As his feet leave platform 104, his feet no longer block the light beam 120, and the light beam 120 is therefore able to reach the detector 114. The detector 114 sends a signal to the computer to notify the computer that the light beam 120 was detected. The computer interprets this to mean that the athlete 102 has jumped.

At time t₃ the athlete 102 is at the apex of his jump, at time t₄ the athlete 102 is descending, and at time t₅ he lands on the platform 104. When he lands on the platform 104, the feet of the athlete 102 once again obstruct the light beam 120, and thus the light beam 120 does not reach the detector 114. The athlete 102 remains on the platform 104 in the given example, and at time t₆ he is ready to jump again. At time t₇ his feet leave the platform 104 again, and the light beam 120 again reaches the detector 114. The detector 114 notifies the computer that the detector 114 detects light, and the computer interprets that to mean that the athlete 102 has jumped again. The athlete 102 continues this process until he has jumped a predetermined number times, e.g., 3 as shown in the figure.

The prior art jump detection system determines the amount of time that the feet of the athlete 102 were in contact with the platform 104 in between jumps. This is accomplished by subtracting times between jumps, in this case time t₅ is subtracted from time t₆ and time t₁₀ is subtracted from t₁₁, respectively. These times are referred to as the contact times.

If the contact time is comparatively long, the system may determine that the athlete 102 is not ready to engage in a full workout, for example, because he may not have properly warmed up his muscles or because he is not sufficiently recovered from prior training. If the contact time is relatively short, the system may determine that the athlete 102 is ready to engage in a strenuous workout, for example, because he properly warmed up his muscles and/or because he is sufficiently recovered from prior training.

The data generated from prior art jump systems is helpful to determine the countermovement vertical jump performance of an athlete and thus the training readiness of the athlete, however the prior art systems are bulky and expensive. In addition, these jump test are not available to the average consumer but rather must be completed at a specific location (i.e., a location where a platform 104 is located). There exists a need for a simpler, less expensive way to determine an athlete's readiness; ideally no platform would be required.

There exists an opportunity to arm athletes with precise, reliable information on individualized jump performance via practical, portable means, thereby enabling fatigue-monitoring, recovery status tracking, and immediate assessment of training readiness. The present disclosure provides a simpler, less expensive system and method to measure single or repeated-jump performance to monitor neuromuscular fatigue and determine an athlete's readiness, which does not require the use of light sensors on a jumping platform. Such systems and methods will described in further detail below.

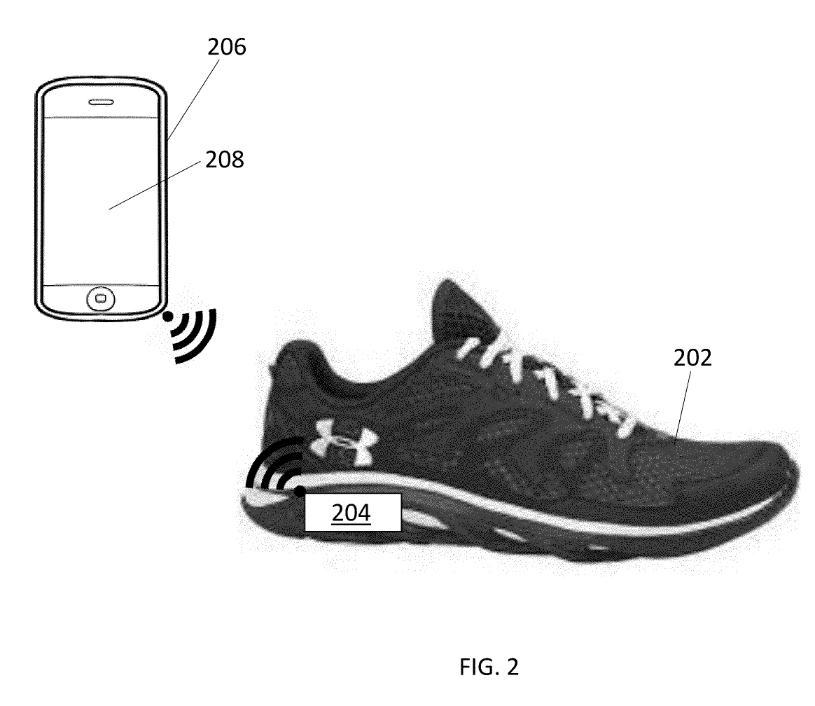

FIG. 2 illustrates an exemplary readiness testing system in accordance with one embodiment of the present disclosure.

As shown in the figure, a shoe 202 includes an evaluation pod 204, and is in communication with a mobile device 206 which includes a display 208.

The shoe 202 may be any type of athletic shoe adapted to receive or connect to the evaluation pod 204 and/or any other type of activity tracking device (not shown).

The evaluation pod 204 may be any type of device or system that is configured to detect the magnitude and direction of acceleration of an object.

In the illustrated embodiment, the evaluation pod 204 is included in the sole of the shoe 202. However it is appreciated that the pod 204 may be placed at other locations in or on the shoe 202 that still allow the evaluation pod 204 to measure the acceleration of the shoe 202.

The mobile device 206 may be any type of device or system that can wirelessly communicate with the evaluation pod 204. Non-limiting examples of a mobile device 206 include e.g., cellular phones, smartphones, fitness trackers, tablet computers, and laptop computers. Non-limiting examples of ways in which the mobile device 206 and the evaluation pod 204 may communicate wirelessly include e.g., Wi-Fi, cellular network, Bluetooth, and radio frequency.

The display 208 may be any type of device that is configured to display information on a mobile device 206. A non-limiting example of a display 208 is a touchscreen.

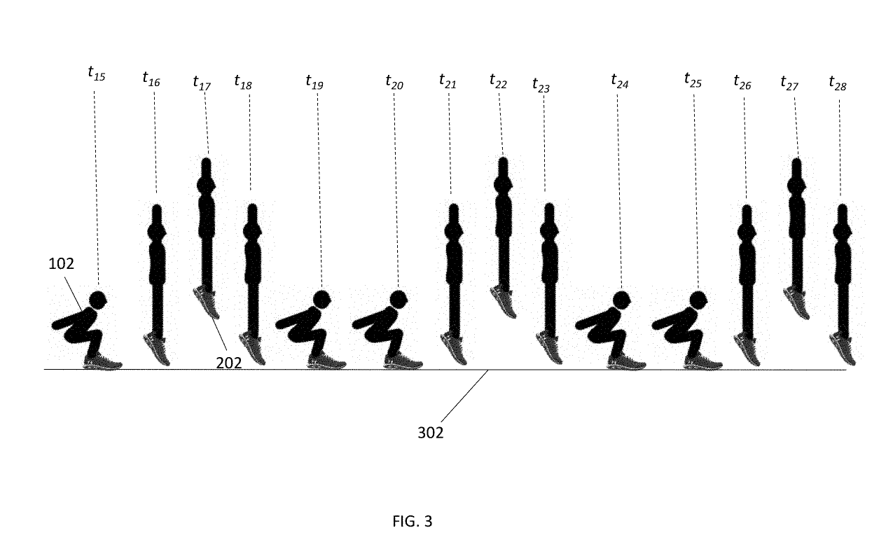

The use of the shoe 202 and the communication device 206 to evaluate readiness in accordance with aspects of the present disclosure will be described below with reference to FIGS. 3-9.

FIG. 3 illustrates an exemplary readiness testing system in accordance with one embodiment of the present disclosure.

As shown in the figure, the athlete 102 is wearing the shoe 202, and the athlete 102 is on a surface 302. Additionally, although not shown, in one embodiment, the athlete stands and jumps with his/her hands on his/her hips, i.e., akimbo. Jumping with ones hands on hips and without swinging ones arms reduces variability. That is, swinging arms during jumps (as performed in prior art systems) introduces variability to the drill, confounds analysis, and compromises the informatics.

Unlike prior art jump test systems described above, the surface 302 may be any reasonably hard, stable, and level surface on which the athlete 102 chooses to perform a jump test, i.e., an ordinary surface. Non-limiting examples of the surface 302 include grass, cement, asphalt, concrete, hardwood, and carpet.

In this example embodiment, suppose the athlete 102 desires to work out, but he is not sure what kind of the workout intensity or training load he should bear. In order to make the determination, the athlete 102 performs a jump test. In one variant, the average contact time is determined after a predetermined number of jumps (e.g., three jumps) and used in calculations which inform the athlete's 102 readiness. A short average contact time may indicate that the athlete 102 is ready for a strenuous workout, but a long average contact time may indicate that the athlete 102 needs to conduct a less stressful workout. Because the athlete 102 is wearing the shoe 202 that is equipped with the evaluation pod 204, the athlete 102 does not need to worry about finding a jump test platform which is specially equipped with sensors and computers. Instead, he can simply perform the jump test on any surface 302 that is reasonably hard, level and stable.

At time t₁₅, the athlete 102 is preparing to jump from the surface 302. At time t₁₆, the athlete 102 jumps from the surface 302 and is in the air until time t₁₈. At time t₁₉, the athlete 102 lands on the surface 302, and at time t₂₀, the athlete 102 is preparing to jump from the surface 302 again. At time t₂₁, the athlete 102 jumps from the surface 302 again and is in the air until time t₂₃. At time t₂₄, the athlete 102 lands on the surface 302 again, and at time t₂₅, the athlete 102 is preparing to jump from the surface 302 again. At time t₂₆, the athlete 102 jumps from the surface 302 again and is the air.

From this example embodiment of a repeated jump test, two contact times can be determined. Contact time ct₁ is the time the shoe 202 is on the surface 302 between the first and second jumps, which is equal to the difference between t₂₀ and t₁₉. Contact time ct₂, is the time the shoe 202 is on the surface 302 between the second and third jumps, which is equal to the difference between t₂₅ and t₂₄.

Although only three jumps are illustrated in the presented example, it is appreciated that any number of jumps may be requested of the athlete 102 in order to measure and monitor jump performance the data for which is then used to ascertain the athlete's 102 readiness. In one specific variant, the athlete 102 may be prompted (via the display 208 of the mobile device 206) to perform six jumps in order to determine readiness.

Ground contact time and/or air time or flight time during a countermovement jump is a direct result of force production. Flight time of repeated jumps reflects the presence of neuromuscular fatigue, both short-term (acute) fatigue resulting from a strenuous workout and chronic fatigue (muscle “hangover”) accumulated over days or weeks. Among various measures of jump performance (e.g., peak or mean power, peak/mean force, peak velocity, ground contact time, etc.) flight time is consistently referenced as the most reliable marker of neuromuscular fatigue across a range of athlete populations and levels. Although jump height may be estimated from flight time, flight time as a direct measure is a favored methodology (to ascertain vesiges of fatigue) for its simplicity. The herein-discussed mechanisms reinforce this simplicity, recording flight time over a number of jumps, taking an average of the several flight times, and reporting the average flight time (e.g., as a score).

In another embodiment, the determined readiness may be based on any number of additional or alternative factors including without limitation, acceleration, contact time, jump height, total time of testing, air time, flight time, mean leg power, peak leg power or any combination thereof, estimated or derived from the average flight time (and additional information, e.g., body weight, in some embodiments). In yet another embodiment, the collected data regarding any particular jump may be reviewed relative to previous jumps in the same test, in previously logged tests, by other athletes, and/or stored data relating to a “normal value” or reference range derived from the athlete's 102 gender, height, weight, etc. For example, it may be determined that the average jump height across all jumps in the current test session is much lower than the athlete's 102 average jump height for a previously jump test session and thus the athlete 102 may have a limited capacity to perform and thus a decreased readiness score. In another example, it may be determined that the acceleration or explosiveness of the athlete's 102 jumps in a present jump test session far exceeds the same athlete's 102 to date highest acceleration rate and thus the athlete 102 may be determined to be in top condition and should be advised to work harder or do more in a current workout than previously done. Specific relationships between the readiness factors (e.g., acceleration, contact time, jump height, total time of testing, air time, etc.) may also be examined and readiness conclusions may be drawn therefrom as well.

As discussed in greater detail elsewhere herein, the readiness score is then relied upon by the athlete 102 and/or coach in determining an intensity level of the athlete's upcoming workout. For example, an athlete who receives a low readiness score may elect to perform a light or low intensity workout, and an athlete who receives a high readiness score may elect to perform a heavy or high intensity workout. In yet another variant, the system may be further configured to select one or more appropriate workouts or exercises from a database comprising a plurality of workouts and/or exercises each being associated to a different one of the available readiness scores. Thus, the user may be given a choice between various workouts or exercises (which he may use to build a workout in one variant), that match the athlete's current readiness.

It is further contemplated that the herein discussed readiness score may provide a reliable measure of performance that reflects current fatigue and recovery status ahead of a workout. Thus the user is able to potentially avoid muscle damage and/or mitigate the risk of illness or injury from overtraining (i.e., performing in an under-recovered state). In one specific embodiment, the system is configured to remind the user to perform the herein-described jump testing a predetermined number of times per week, such as bi-weekly, daily, etc.

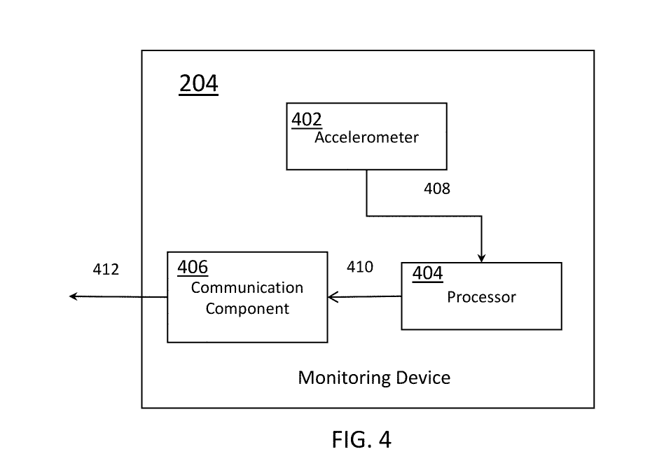

FIG. 4 illustrates exemplary evaluation pod in accordance with one embodiment of the present disclosure.

As shown in the figure, the evaluation pod 204 includes an accelerometer 402, a processor 404 and a communication component 406.

In this example embodiment, the accelerometer 402, the processor 406, and the communication component 404 are shown as independent components. However, in some embodiments, at least two of the accelerometer 402, the processor 406, and the communication component 404 may be combined as a unitary device. Further, in some embodiments, at least one of the processor 406 and the communication component 404 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

The accelerometer 402 is arranged to communicate with the processor 404 via a communication channel 408. The accelerometer 402 may be any device or system that is able to detect acceleration or a change in acceleration.

It is further appreciated that the evaluation pod 204 may further comprise a timer which is configured to measure time of an individual jump (the beginning and end of which being determined based on the sensed positive, negative, and zero acceleration) as well as measure the time of the entire duration of the jump test.

The processor 404 is additionally arranged to communicate with the communication component 406 via a communication channel 410. The processor 404 may be any device or system that is able to process a signal provided by the accelerometer 402.

In one embodiment, the processor 404 is configured to run one or more applications thereon which enable the herein described functionality. For example, the processor 404 may run at least one application which is configured to cause the pod 204 to automatically begin measuring or sensing at least one of force, acceleration, velocity, time, etc. upon receipt of a trigger received from an application running at the mobile device 206. In another example, the processor 404 may run at least one application which is configured to cause the pod 204 to transmit the collected data relating to force, acceleration, velocity, time, etc. to the mobile device 206 (such as via the communication component 406).

It is appreciated that the processor 404 may comprise additional applications which contribute to the functioning thereof as described herein. These and other components of the evaluation pod 204 will be clear to a person of ordinary skill in the art given the discussion of the functionality herein.

The herein-described applications improve the functioning of the evaluation pod 204 by enabling it to obtain and transmit data relating to various parameters of an athlete's jump test. Furthermore, shoe mounted devices that are able to obtain and transmit jump test data as disclosed herein can operate to more effectively enable readiness determinations as discussed herein.

The communication component 406 is additionally arranged to wirelessly communicate with the mobile device 206 via a communication channel 412. The communication component 406 may be any device or system that is able to transmit a signal to the mobile device 206.

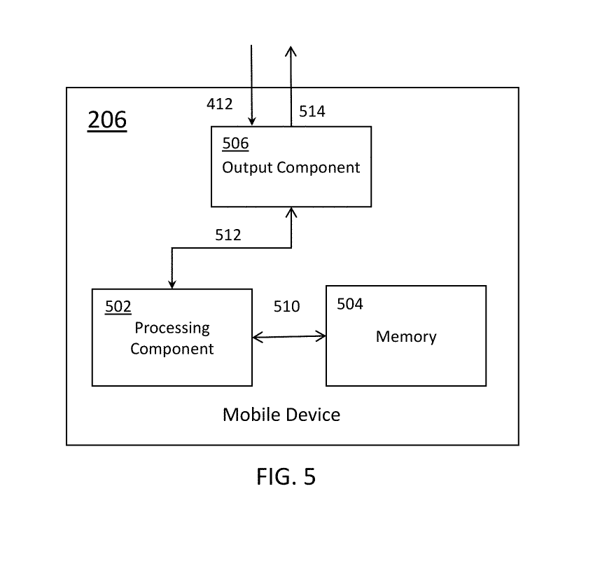

FIG. 5 illustrates an exemplary mobile device in accordance with one embodiment of the present disclosure.

As shown in the figure, the mobile device 206 includes a processing component 502, a memory 504, and a communication component 506.

In this example embodiment, the processing component 502, the memory 504, and the communication component 506 are shown as independent components. However, in some embodiments, at least two of the processing component 502, the memory 504, and the communication component 506 may be combined as a unitary device. Further, in some embodiments, at least one of the processing component 502, the memory 504, and the communication component 506 may be implemented as a computer having tangible computer-readable media for carrying or having computer-executable instructions or data structures stored thereon.

The processing component 502 communicates with evaluation pod 204 via the communication channel 508, with the communication component 506 via the communication channel 512, and with the memory 504 via the communication channel 510.

The communication channel 512 may be any type of conventional communication channel that would facilitate communication between the processing component 502 and the evaluation pod 204. Non-limiting examples of the communication channel 512 include Wi-Fi, Bluetooth, cellular network, and radio frequency. The processing component 502 and the evaluation pod 204 may initiate a connection via any type of conventional connection mechanism or system, including a handshake.

The processing component 502 may be any type of device or system that receives data from the evaluation pod 204 and the memory 504, analyzes the data, and provides the analyzed data to the communication component 506.

In one embodiment, the processing component 502 is configured to run one or more applications thereon which enable the herein described functionality. For example, the processing component 502 may run one or more applications which are configured to: trigger the pod 204 to begin and to terminate collection of data; instruct the athlete 102 to perform the jump test; receive the force, acceleration, velocity, time, etc. data from the pod 204; generate meaningful data from the collected raw data; compare the collected data in order to arrive at a readiness score or level; and cause the readiness score or level to be displayed to the athlete 102.

It is noted that in one embodiment, the instructions to perform the jump test may include a countdown timer to notify the user when the jumping is to begin. In addition, the instructions may include one or more audio and/or video cues, instructions, or demonstrations. For example, the user may be directed to perform jumps repeatedly, for maximal air time, and with minimal pause at the athlete's self-selected squat depth between jumps.

In one specific embodiment, the program running on the processing component 502 may further facilitate pairing of the pod 204 to the mobile device 206.

It is further appreciated that in another embodiment, the display of the readiness score to the athlete 102 may be relied upon by the athlete 102 in determining an intensity level of his upcoming workout. Still further, the system may be configured to display or provide one or more appropriate workouts and/or individual exercises from a database comprising a plurality of workouts and/or exercises. It is appreciated that the database may mark or flag each exercise and/or workout as being associated to a different one of the available readiness scores. Accordingly, the user may be given a choice between various workouts or individual exercises that match the athlete's current readiness. In another variant, the athlete may be given an opportunity to craft a workout of his own via selection of individual exercises associated to his readiness score; the number of repetitions and/or duration also being determined by his readiness score.

It is appreciated that the processing component 502 may comprise additional applications which contribute to the functioning of the mobile device 206. These and other components of the mobile device 206 will be clear to a person of ordinary skill in the art given the discussion of the functionality herein.

The herein-described applications improve the functioning of the mobile device 206 by enabling it to manage the athlete's performance of a jump test and associated data collection. In addition, the mobile device is able to generate meaningful data from the collected jump data and via comparisons determine and display a readiness level of the athlete. Furthermore, mobile devices that are able to manage a jump test and determine an athlete's readiness level as disclosed herein can operate to more effectively enable the athlete to make informed decisions with regard to an intensity level of his workout.

The memory 504 communicates with the processing component 502 via the communication channel 510.

The memory 504 may be any device or system that stores data provided by the processing component 502 and provides the data to the processing component 502 when needed. Non-limiting examples of memory include: physical storage and/or memory media such as RAM, ROM, EEPROM, CD-ROM or other optical disk storage, magnetic disk storage or other magnetic storage devices.

The memory 504 may also contain a priori data to which the data from the processing component 502 may be compared. A priori data may be data previously generated by the athlete, or it may be data pre-loaded on the memory 504 by the manufacturer, or it may be data previously generated by other athletes. The a priori data may include a lookup table or a database that references one or more associations between a detected parameter and a previously generated parameter.

Non-limiting examples of a priori data within memory 504 include data such as contact time between a first and second jump, contact time between a second and third jump, the difference between contact times, total contact time, air time of a first jump, air time of a second jump, air time of a third jump, the difference between air times, total air time, jump height, total time of testing, and jump acceleration. A priori data may also include functional relationships between two or more data.

Using raw a priori data or functional relationships between data may provide an output that corresponds to one or more aspects of an athlete's performance including, but not limited to, readiness, fitness, fatigue, and recovery status.

Moreover, the memory 504 may be further configured to store a number of previous readiness scores and thereby enable identification of patterns within the jump performance (e.g., average flight time) data that indicates recovery status over time.

The communication component 506 communicates with the processing component 502 via the communication channel 512, and with the display 208 via the communication channel 514.

The communication component 506 may be any device or system that receives data from processing the component 502 and provides the data to the display 208 so the athlete 102 can view the data.

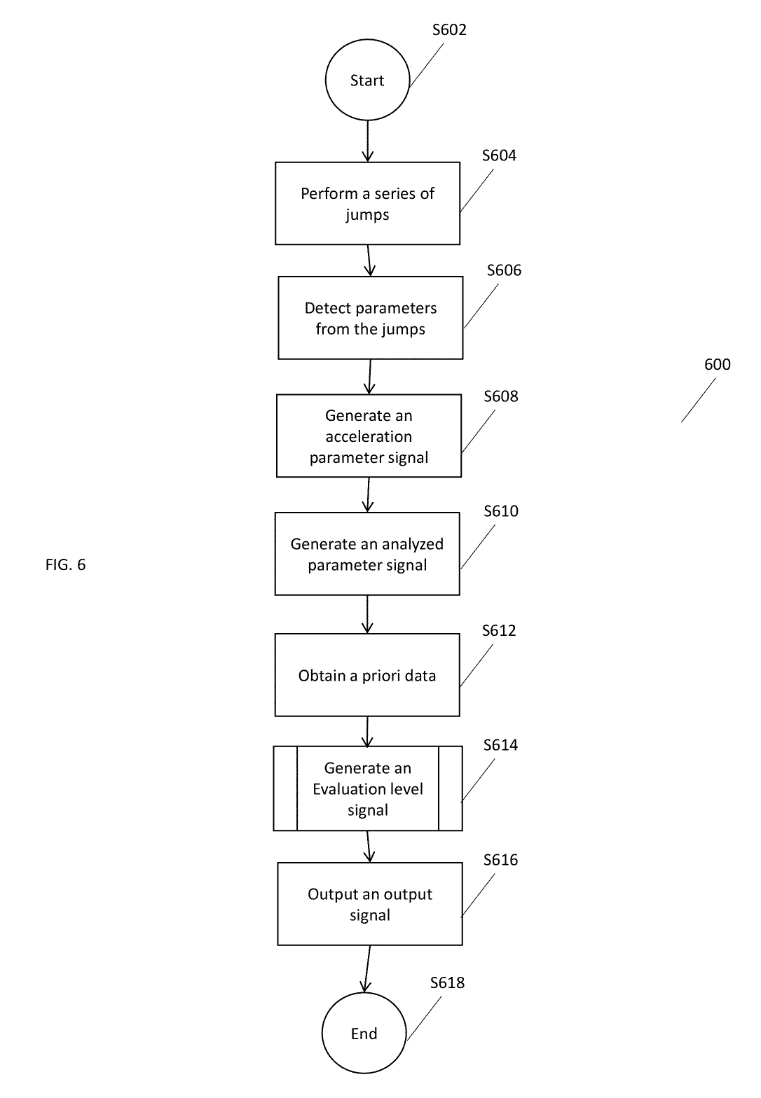

In accordance with aspects of the present disclosure a user may be monitored via a multi jump test by way of the monitoring device 204. In some embodiments, the monitoring device 204 additionally processes the data to provide the user with an evaluation. In other embodiments, the monitoring device 204 provides the monitored data to the mobile device 206; the mobile device 206 then provides the user with an evaluation. For purposes of brevity, an example embodiment wherein the monitoring device 204 provides the monitored data to the mobile device 206, and the mobile device 206 then provides the user with an evaluation will now be further described with additional reference to FIGS. 6-9C.

FIG. 6 illustrates an exemplary method for determining the readiness of an athlete in accordance with one embodiment of the present disclosure.

As shown in the figure, the process 600 starts (S602) and an athlete performs a series of jumps (S604). In one embodiment, the athlete 102 performs a jump test as described above with regard to FIG. 3.

However, it is appreciated that in another embodiment (not shown), the user may first establish a baseline jump score or reference performance range. In one variant, this baseline or range is reset every few sessions (e.g., every 12 sessions, once a month, etc.). As discussed herein, newly obtained jump test scores may be referenced against this baseline or range. Jump-test sessions which determine a baseline or reference range proceed in a manner similar to that discussed herein with respect to FIG. 6, however, the scores derived therefrom serve as a basis for comparison against future scores.

Referring back to FIG. 6, parameters are detected from the jumps (S606). Using the example of FIG. 3, the evaluation pod 204 in the shoe 202 detects one or more parameters as the athlete 102 is jumping. The parameters which the evaluation pod 204 may detect include acceleration, changes in acceleration, and combinations thereof (as well as others discussed herein). For example, when the athlete 102 lands at time t₁₉ the evaluation pod 204 may detect a highly negative acceleration, indicating that the foot of the athlete 102 has landed on the surface 302. Then, as the foot of the athlete 102 remains on the surface 302 through time t₂₀ the evaluation pod 204 may detect zero acceleration, indicating that the foot or footwear of the athlete 102 has remained stabilized or fixed on the surface 302. At time t₂₁, the evaluation pod 204 may detect a highly positive acceleration, indicating that the foot of the athlete 102 has left the surface 302.

Returning to FIG. 6, an acceleration parameter signal is generated (S608). In one example, referring to FIG. 5, the evaluation pod 204 generates an acceleration parameter signal based on the acceleration parameters detected during the jump test, and then the evaluation pod 204 sends the acceleration parameter signal to the processing component 502 via the communication channel 508.

In some embodiments, the evaluation pod 204 may additionally include a timer and a processing component. The timer may be utilized to initiate and cause display of a “countdown” indicating when the user should begin a jump test. Continuing the example of FIG. 3, the evaluation pod 204 may determine the time in air (“air time”), for example by the calculating a difference between t₁₉ and t₁₅. Using various kinetic equations, with a known gravitational acceleration, other parameters of the jump may be determined such as lift-off velocity and maximum height of the jump.

Further, other parameters may be determined, non-limiting examples of which include overall time in air, total time for all jumps, average time in air, difference in time in air between any or all jumps, difference in lift-off velocity between any or all jumps, average lift-off velocity, difference in maximum height between any or all jumps, average height, and combinations thereof. Such other determined parameters may also be used to evaluate a user's readiness.

Returning to FIG. 6, an analyzed parameter signal is generated (S610). Using the example of FIG. 5, in some embodiments, the processing component 502 receives the acceleration parameter signal from the evaluation pod 204 and analyzes the acceleration parameter signal to generate an analyzed parameter signal. The analyzed parameter signal may indicate the contact times for the athlete 102 during the jump test.

In other embodiments, the evaluation pod 204 may analyze the acceleration parameter signal to generate an analyzed parameter signal. In these embodiments, the evaluation pod 204 may then provide the analyzed parameter signal to the processing component 502.

Returning to FIG. 6, a priori data is obtained (S612). Per FIG. 5, the memory 504 may provide the processing component 502 with a priori data to which the analyzed parameter signal can be compared. In one embodiment, the manufacturer may have pre-loaded the memory 504 with known contact time thresholds that indicate the readiness level of an athlete. In another embodiment, the memory 504 may contain a priori data from the athlete's 102 previous jump test sessions. In yet other embodiments, the memory 504 may contain a combination of a priori data pre-loaded by the manufacturer and a priori data generated by the athlete during previous tests. In other embodiments, the memory 504 may contain a priori data related to different workouts the athlete 102 can perform based on the determined readiness level.

In one embodiment, the athlete 102 may be performing the jump test for the first time, and the memory 504 may provide pre-loaded contact time (or other measured/determined parameter) thresholds because no data currently exists for the specific athlete 102. In other embodiments, the athlete 102 may have performed a plurality of jump tests previously, so the memory 504 may provide contact time (or other measured/determined parameter) thresholds based on contact time data previously generated relating to the athlete 102.

Returning to FIG. 6, an evaluation level signal is generated (S614). As demonstrated in FIG. 5, the processing component 502 compares the analyzed parameter signal to the a priori data to generate an evaluation level signal, and the processing component 502 sends the evaluation level signal to the communication component 506.

For example, the analyzed parameter signal may correspond to the contact times for the athlete during the jump test session. The processing component 502 compares the contact times for the athlete 102 during the jump test to the a priori contact time data from the memory 504 to find a priori data that most closely matches the data provided by the athlete 102. When the most closely matched a priori data is found, the memory 504 provides the processing component 502 with additional data corresponding to the a priori data. The additional data may indicate the typical fitness level, or readiness level, of an athlete that generated the a priori data. The data relating to the athlete's 102 performance of the jump test is then associated to the a priori data, thus the processing component 502 generates an evaluation level signal that corresponds to the fitness level, or readiness level, assigned to the a priori data.

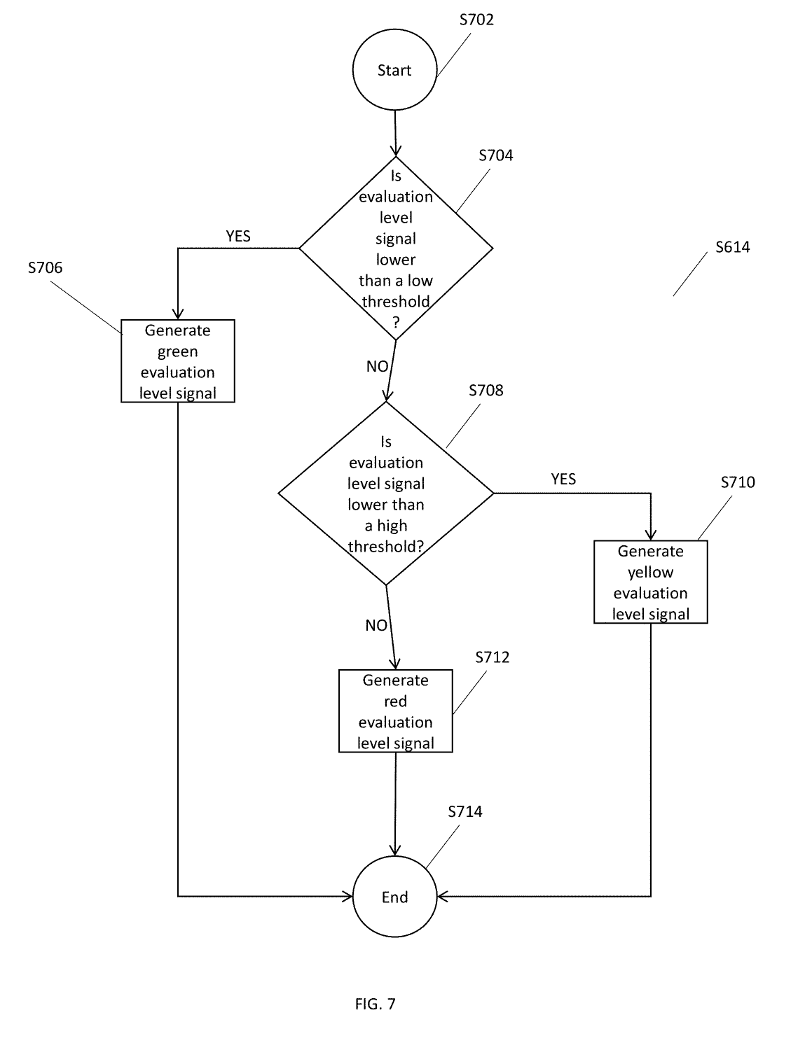

FIG. 7 illustrates another exemplary method for determining a readiness level of an athlete in accordance with another embodiment of the present disclosure.

As shown in the figure, process starts (S702) and the processing component 502 determines if the evaluation level signal is lower than a predetermined low threshold (S704). In an example embodiment, a user's readiness is evaluated based on ground contact time, however other parameters and/or combinations of parameters may be utilized with equal success.

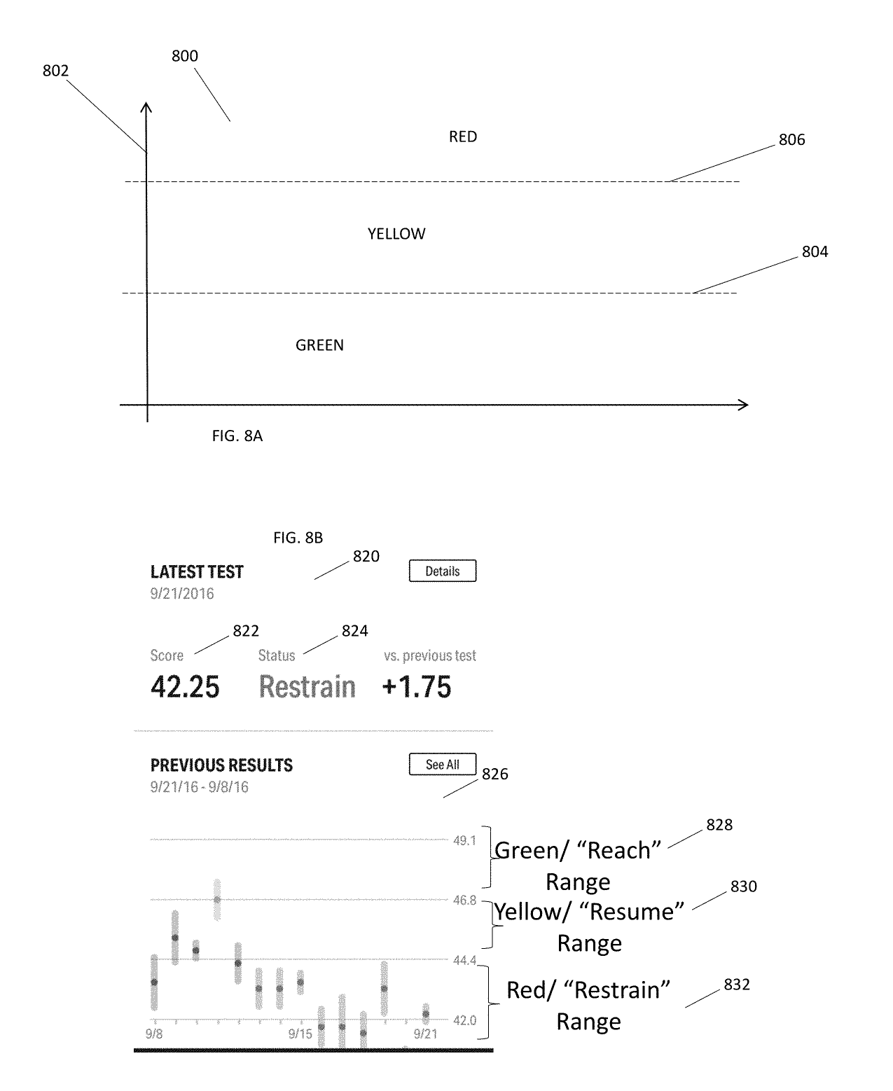

FIG. 8A illustrates various exemplary ground contact time thresholds utilized for determining readiness in accordance with one embodiment of the present disclosure.

As shown in the figure, a graph 800 includes a y-axis 802, a contact time low threshold 804, and a contact time high threshold 806. The y-axis 802 shows the contact times measured during a jump test like the one shown in FIG. 3.

In attempting to determine the type of workout to perform, an athlete may desire to determine his readiness level before engaging in a workout to make sure he is performing a workout that is tuned to his body's capacity to perform. The athlete's readiness level may be determined by the contact time measured during a jump test, or any other performance metric based on one or more measurable parameters relating to the athlete's jump test. If the contact time is lower than contact time low threshold 804, the athlete may have a high readiness level, meaning he may be ready to perform a relatively strenuous workout. If the contact time is between contact time low threshold 804 and contact time high threshold 806, the athlete may have an intermediate readiness level, meaning he may be ready to perform a relatively average, standard, or typical workout. If the contact time is higher than contact time high threshold 806, the athlete may have a low readiness level, meaning he may have limited capacity to perform a relatively standard workout and instead should perform a relatively easy workout, if anything. In some embodiments, contact time thresholds 804 and 806 may be generated from a priori data located in memory 504. In other embodiments, contact time threshold 804 and 806 may be generated from previous jump test sessions completed by the athlete and stored in memory 504. Similar logic applies to other parameters of the athlete's jump.

Returning to FIG. 8A, the processing component 502 compares the evaluation level signal generated during the jump test to the a priori data in the memory 504. In one embodiment, a priori data provides contact time thresholds 804 and 806.

Returning to FIG. 7, if the processing component 502 determines that the evaluation level signal falls below the contact time low threshold 804 (YES at S704) then the processing component 502 generates a “green” evaluation signal (S706) indicating that the athlete has a high readiness level. At this point the process of generating an evaluation level signal ends (S714).

If the processing component 502 determines that the evaluation level signal does not fall below the contact time low threshold 804 (NO at S704), then the processing component 502 must determine whether the evaluation level signal falls below contact time high threshold 806 (S708). When the processing component 502 determines that the evaluation level signal falls below the contact time high threshold 806 (YES at S708) then the processing component 502 generates a “yellow” evaluation signal (S706) indicating that the athlete has an intermediate readiness level. The process of generating an evaluation level signal ends (S714).

If the processing component 502 determines that the evaluation level signal does not fall below the contact time high threshold 806 (NO at S708), then the processing component 502 generates a “red” evaluation signal (S712) indicating that the athlete 102 has a low readiness level. The process of generating an evaluation level signal ends (S714).

Returning to FIG. 6, after the evaluation level signal is generated (S614), an output signal is outputted (S616). As illustrated in FIG. 5, the communication component 506 receives the evaluation level signal from the processing component 502 via the communication channel 512. The communication component 506 then provides the evaluation level signal to the display 208 for display thereof to the athlete 102.

Referring now to FIG. 8B, an exemplary graphical user interface 820 for displaying one or more flight time representations and a readiness score for an athlete is given. As shown, the interface 820 provides at an upper portion thereof, a review of the user's current jump test session. As discussed above, the user's jump test session is comprised of several jumps. At the upper portion of the interface 820, a readiness score 822 and a recommendation 824 based on an average for the current jump test session are provided. In the illustrated example, the display further shows a comparison of the current session to the most previous session. Also in the illustrated example, the user's jump test score is lower than a baseline range, and therefore, the user is given the recommendation to “Restrain”. In other embodiments, alternative recommendations and/or indications may be provided (e.g., “low”, red, etc.), the foregoing being merely exemplary.

At a lower part of the graphical user interface 820, a graph 826 of previous jump test sessions is provided. The metric of the y-axis illustrates flight time displayed in centiseconds, i.e. milliseconds/10; while jump test session dates are listed on the x-axis. The graph 826 de-emphasizes flight time (which is conventionally displayed in ms) and instead encourages users to focus on variability. In the graph 826, for each day, an elongated oval represents the standard deviation (+/−1 SD) computed from a plurality of scored flight times. In one embodiment, the user may jump e.g., six times per jump test session; but only the most clustered ones of the flight times are scored. The mean value of the scored flight times is denoted for each jump test session by the darkened spot within the elongated oval; and the shaded portions extending therefrom (i.e., wings) denote the standard deviation thereof. The standard deviation is used in concert with the jump score (mean flight time) in one embodiment to determine recovery status.

Finally, in one exemplary embodiment, the range of readiness scores and/or flight times may be associated to one of various readiness level indicators as illustrated at FIG. 8B. Specifically, scores within a given range of the user's baseline score are associated to the yellow or “Resume” range 830. Values above and below this range are categorized as green/“Reach” values 828 and red/“Restrain” values 832, respectively.

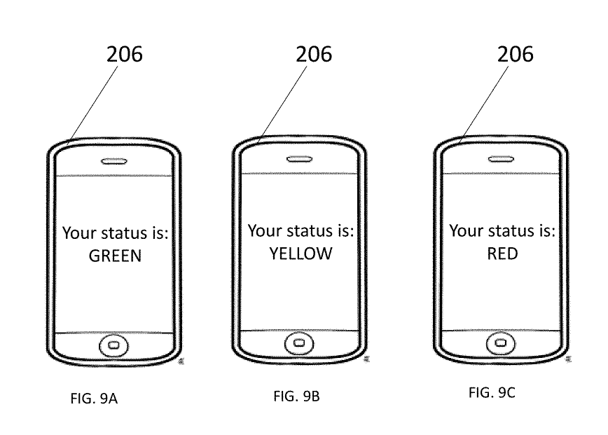

FIGS. 9A-C illustrates a mobile device displaying exemplary readiness levels of an athlete in accordance with one embodiment of the present disclosure.

Referring to FIG. 9A, when the evaluation of the athlete 102 via a jump test determines that the athlete 102 has a high readiness level, the display 208 may communicate the readiness level to the athlete 102 by indicating his readiness level is “green” on the display 208. In another embodiment, for example, as shown in FIG. 9B, when the athlete 102 has an intermediate readiness level, the display 208 may communicate the readiness level to the athlete 102 by indicating his readiness level is “yellow” on the display 208. In yet another embodiment, for example as shown in FIG. 9C, when the athlete 102 has a low readiness level, the display 208 may communicate the readiness level to the athlete 102 by indicating his readiness level is “red” on the display 208.

With this information, the athlete 102 can tailor his workout intensity to his current readiness level so that he is neither overexerting himself when he has a low readiness level, nor underexerting himself when he has a high readiness level. In some embodiments, the display 208 may further provide the athlete 102 a specific workout tailored to the readiness level of the athlete 102 so that the athlete 102 does not have to generate his own workout. In another embodiment, the display 208 may simply display a message which corresponds to the readiness level to indicate whether the athlete 102 should “workout hard today”, “take it easy today”, “use a steady pace today”, or other similar indicator of a high, low, or medium workout readiness.

In a further embodiment, the readiness level may be displayed as shown at FIG. 8B. Specifically, the user may be notified to “Resume”, “Reach”, or “Restrain”. The “Resume” indicator denotes jump performance that falls within the normal range for the user as determined by the user's baseline jump test sessions. If a jump test session score falls within the baseline or reference range limits, then no significant fatigue is detected and a workout may resume as planned. “Reach” denotes a score registered above the upper control limit, suggesting that the user has an added capacity to withstand a training load. “Restrain” denotes a score registered below the lower control limit, suggesting that the user may be fatigued, not fully recovered from prior training, or potentially lacking capacity for a workout of normal intensity or duration.

Returning to FIG. 6, the process 800 ends (S618).

In summary, the present disclosure provides a device for an athlete to perform a jump test at any location without the need for additional equipment including relatively unwieldly, expensive systems that employ light gates and/or force plates. Rather, the athlete uses an accelerometer embedded within a shoe and in communication with a mobile computer application to determine readiness. In addition, the present disclosure provides a method to determine, based on e.g., the contact and/or flight times of a jump test session, the readiness level of the athlete so that the athlete can work out at a level corresponding to his readiness level.

The foregoing descriptions of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

It will be appreciated that the various ones of the foregoing aspects of the present disclosure, or any parts or functions thereof, may be implemented using hardware, software, firmware, tangible, and non-transitory computer readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for determining a readiness of a user, the method comprising:
establishing communication between a mobile device associated to the user and a sensor disposed in or on at least one shoe of the user;
providing via a display of the mobile device an instruction to the user to perform one or more jumps;
transmitting a signal from the mobile device to the sensor, the signal causing the sensor to begin collection of data, and the transmission being timed to coincide with the performance of the one or more jumps;
receiving from the sensor the data relating to the performance of the one or more jumps;
processing the data at a processor of the mobile device to determine a readiness score of the user; and
displaying at least the readiness score to the user via the display of the mobile device.

2. The method of claim 1, wherein the act of processing comprises comparing the data relating to the performance of the one or more jumps to data stored at a memory apparatus of the mobile device.

3. The method of claim 2, wherein the data stored at the memory apparatus of the mobile device comprises stored data relating to one or more previous performances of the one or more jumps by the user.

4. The method of claim 2, wherein the data stored at the memory apparatus of the mobile device comprises data which was downloaded from one or more databases of data relating to one or more previous performances of the one or more jumps by one or more second users.

5. The method of claim 1, wherein the data relating to the performance of the one or more jumps comprises one or more of: acceleration, contact time, flight time, total time, velocity, and height.

6. The method of claim 5, wherein the act of processing the data comprises identifying a relationship between the one or more of: acceleration, contact time, flight time, total time, velocity, and height data and comparing the relationship to that stored at a memory apparatus of the mobile device.

7. The method of claim 1, wherein the act of displaying further comprises displaying at least one general instruction relating to a recommended intensity of a workout based at least in part on the readiness score.

8. A non-transitory, computer readable medium comprising a plurality of instructions which are configured to, when executed, cause a user device to:
associate a sensor disposed at a shoe to a user which is also associated to the user device;
display an instruction to the user to perform one or more jumps at a specified time;
transmit a signal to the sensor at the specified time to begin collection of data relating to the performance of the one or more jumps;
receive the data relating to the performance of the one or more jumps;
compare one or more aspects of the data to a performance standard or reference range therefor;
based on the comparison, identify a readiness score; and
display the readiness score and at least one workout or training recommendation based thereon to the user.

9. The computer readable medium of claim 8, wherein the association of the sensor to the user of the user device comprises utilization of a handshake-based connection mechanism.

10. The computer readable medium of claim 8, wherein the instruction comprises an instruction for the user to perform three jumps and the specified time is displayed to the user via a countdown timer mechanism.

11. The computer readable medium of claim 8, wherein the data relating to the performance of the one or more jumps comprises one or more of: acceleration, contact time, flight time, total time, velocity, and height.

12. The computer readable medium of claim 11, wherein:
the one or more aspects of the data comprise one or more relationships between the one or more of: acceleration, contact time, flight time, total time, velocity, and height; and
the comparison comprises a comparison of the one or more relationships to a respective one or more stored relationships to determine a threshold level of similarity there between, each relationship being associated to a different one of an available plurality of readiness scores.

13. The computer readable medium of claim 11, wherein the performance standard or reference range utilized for the comparison comprises at least one of: data relating to the performance of one or more jump test sessions previously performed by the user, one or more jump test sessions previously performed by one or more second users, and one or more preset values.

14. The computer readable medium of claim 8, wherein:
when the readiness score is within a first range, the at least one recommendation comprises a recommendation to perform a low intensity workout;
when the readiness score is within a second range, the at least one recommendation comprises a recommendation to perform a medium intensity workout; and
when the readiness score is within a third range, the at least one recommendation comprises a recommendation to perform a high intensity workout.

15. A mobile user device configured to determine a readiness of a user, comprising:
a transceiver apparatus configured to communicate to and from a sensor device disposed at a user's shoe, the user being associated to the mobile user device;
a user interface;
a storage apparatus; and
a processor configured to execute at least one computer application thereon, the computer application comprising a plurality of instructions which are configured to, when executed by the processor cause the mobile user device to:
display via the user interface an instruction for the user to perform one or more jumps;
cause the sensor to collect data relating to the performance of the one or more jumps;
receive the data relating to the performance of the one or more jumps;
determine a readiness score of the user based on a comparison of the data relating to the performance of the one or more jumps to a performance standard or reference range relating thereto and stored in the storage apparatus; and
display the readiness score at the user interface.

16. The mobile user device of claim 15, wherein the instructions comprise:
an audio instruction and/or video demonstration of the number of jumps, including an instruction to maximize time in flight and minimize ground-contact time while descending to a self-selected comfortable depth; and
a countdown timer configured to inform the user when a first jump is to occur.

17. The mobile user device of claim 16, wherein:
the countdown timer is synched to a timer associated to the sensor which initiates the collection of the data relating to the performance of the one or more jumps, and
the data relating to the performance of the one or more jumps comprises one or more of: acceleration, contact time, flight time, total time, velocity, and height.

18. The mobile user device of claim 15, wherein the sensor comprises one or more of:
a timer configured to measure at least the duration of each jump of the one or more jumps and the entire duration for the performance of the one or more jumps; and
an accelerometer configured to measure zero, positive, and negative acceleration.

19. The mobile user device of claim 15, wherein the readiness score comprises a status indicator including one of: a first qualifier indicating the user may perform a hard or high intensity workout, a second qualifier indicating the user may perform a standard or medium intensity workout, or a third qualifier indicating the user may perform an easy or low intensity workout; and the display thereof further comprises one or more example exercises which are recommended to be performed by the user based on the readiness score.

20. The mobile user device of claim 15, wherein the standard data comprises at least one of: data relating to the performance of one or more jumps previously performed by the user, one or more jumps previously performed by one or more second users, and one or more default values.
